(19) United States
(12) Patent Application Publication
(10) Pub. No.: US 2025/0095030 A1
(43) Pub. Date: Mar. 20, 2025

(54) RECOMMENDATION SYSTEM

(71) Applicant: NTT DOCOMO, INC., Tokyo (JP)

(72) Inventors: Yukiko YOSHIKAWA, Chiyoda-ku (JP); Yuki KATSUMATA, Chiyoda-ku (JP); Takashi SUZUKI, Chiyoda-ku (JP)

(73) Assignee: NTT DOCOMO, INC., Tokyo (JP)

(21) Appl. No.: 18/730,869

(22) PCT Filed: Feb. 2, 2023
(86) PCT No.: PCT/JP2023/003473

§ 371 Date: Jul. 22, 2024

(30) Foreign Application Priority Data
Mar. 30, 2022 (JP) 2022-055641

(51) Int. Cl. G06Q 30/0251

(52) U.S. Cl. CPC G06Q 30/0271

(57) ABSTRACT

A recommendation system includes: a user information acquiring unit configured to acquire user information; a content determining unit configured to determine content to be recommended on the basis of the user information; an expression determining unit configured to determine an expression when the determined content is recommended to the user on the basis of the user information; a difficulty information acquiring unit configured to acquire difficulty information indicating a degree of difficulty with which a user adopts a behavior with respect to the determined content; a behavior information acquiring unit configured to acquire behavior information indicating a behavior of a user with respect to a recommendation; and a learning unit configured to learn a recommendation expression determining method in consideration of the degree of difficulty on the basis of the difficulty information and the behavior information.

### TECHNICAL FIELD

The present invention relates to a recommendation system.

### BACKGROUND ART

Patent Literature 1 discloses a system that reflects content based on a customer's taste in a screen with a design based on the customer's taste and recommends the content. This system generates content information which is information on content to be recommended to a customer and template information indicating a template including an area for displaying information included in the content information using learning artificial intelligence on the basis of customer attribute information indicating attributes of a customer and customer behavior history information indicating a customer's behavior history.

### CITATION LIST

### Patent Literature

[Patent Literature 1] Japanese Unexamined Patent Publication No. 2019-61525

### SUMMARY OF INVENTION

Technical Problem

As described in Patent Literature 1, it is possible to enhance an effect of recommendation by determining a recommendation expression (a design of a screen for recommendation in Patent Literature 1) at the time of providing a recommendation. Particularly, by determining a recommendation expression in consideration of a psychological bias (a psychology bias) of a user to be provided with a recommendation, it is possible to further enhance an effect of recommendation. By learning a method of determining a recommendation expression on the basis of reactions of users to recommendations, it is possible to more appropriately determine a recommendation expression.

However, reactions of users to a recommendation are based on an object to be recommended as well as a recommendation expression. Accordingly, appropriate learning may not be carried out when reactions of users are simply used. For example, when content satisfying a user's interest or taste is recommended, it is conceivable that the user use the content regardless of a recommendation expression thereof.

An embodiment of the present invention was invented in consideration of the aforementioned circumstances, and an objective thereof is to provide a recommendation system that can more appropriately perform learning of a method of determining a recommendation expression.

### Solution to Problem

In order to achieve the aforementioned objective, a recommendation system according to an embodiment of the present invention includes: a user information acquiring unit configured to acquire user information related to a user to be provided with a recommendation; a content determining unit configured to determine content to be recommended to a user on the basis of at least a part of the user information acquired by the user information acquiring unit; an expression determining unit configured to determine an expression when the content determined by the content determining unit is recommended to the user on the basis of at least a part of the user information acquired by the user information acquiring unit; a difficulty information acquiring unit configured to acquire difficulty information indicating a degree of difficulty with which a user adopts a behavior with respect to the content determined by the content determining unit; a behavior information acquiring unit configured to acquire behavior information indicating a behavior of a user with respect to a recommendation provided to the user according to determination in the content determining unit and the expression determining unit; and a learning unit configured to learn a determination method performed by the expression determining unit in consideration of the degree of difficulty with which the user to be provided with a recommendation adopts a behavior on the basis of the difficulty information acquired by the difficulty information acquiring unit and the behavior information acquired by the behavior information acquiring unit.

In the recommendation system according to the embodiment of the present invention, a degree of difficulty with which a user adopts a behavior with respect to content to be recommended is considered when the method of determining a recommendation expression is learned. Accordingly, for example, it is possible to exclude an influence of a user's interest or taste from a behavior of a user with respect to a recommendation and to learn a recommendation expression determining method. As a result, with the recommendation system according to the embodiment of the present invention, it is possible to more appropriately perform learning the recommendation expression determining method.

### Advantageous Effects of Invention

According to an embodiment of the present invention, it is possible to more appropriately perform learning of a method of determining a recommendation expression.

### BRIEF DESCRIPTION OF DRAWINGS

FIG. 1 is a diagram illustrating a configuration of a recommendation system according to an embodiment of the present invention.

FIG. 2 is a diagram schematically illustrating a recommendation outline.

FIG. 3 is a table illustrating an example of user information that is used to determine a store to be recommended to a user.

FIG. 4 is a table illustrating an example of information that is used to determine a store to be recommended to a user.

FIG. 5 is a table illustrating an example of information that is used to determine details to be recommended to a user.

FIG. 6 is a table illustrating an example of information that is used to determine an expression to be recommended to a user.

FIG. 7 is a diagram illustrating an example in which an evaluation value is calculated using a psychological bias estimation model.

FIG. 8 is a table illustrating an example of a calculated evaluation value for each psychological bias.

FIG. 9 is a table illustrating an example of information that is used to determine a recommendation expression to a user.

FIG. 10 is a table illustrating an example of information that is used to train a psychological bias estimation model.

FIG. 11 is a diagram illustrating an example in which a psychological bias estimation model is trained.

FIG. 12 is a flowchart illustrating a process flow that is performed by the recommendation system according to the embodiment of the present invention.

FIG. 13 is a diagram illustrating a hardware configuration of the recommendation system according to the embodiment of the present invention.

### DESCRIPTION OF EMBODIMENTS

Hereinafter, a recommendation system according to an embodiment of the present invention will be described in detail with reference to the accompanying drawings. In description with reference to the drawings, the same elements will be referred to by the same reference signs and repeated description thereof will be omitted.

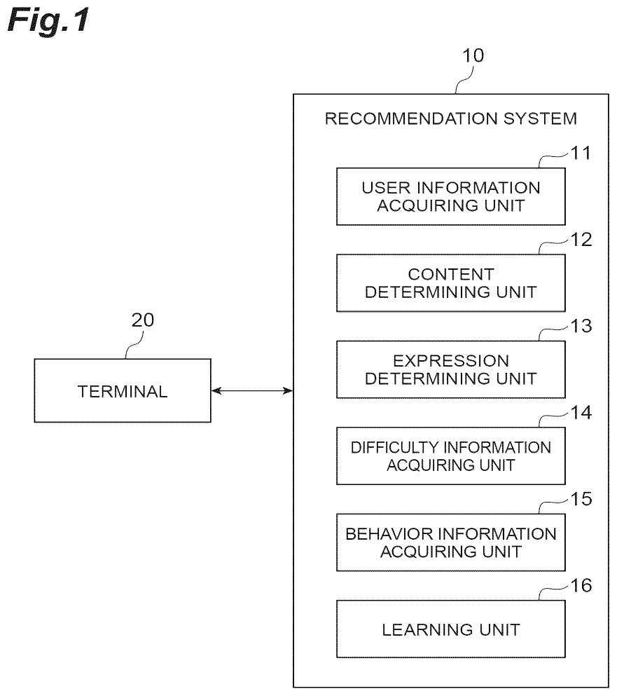

A recommendation system 10 according to this embodiment is illustrated in FIG. 1. The recommendation system 10 is a system (device) that recommends content to a user. In this embodiment, it is assumed that content to be recommended to a user is a restaurant. The content to be recommended to a user is not particularly limited as long as it is an object to be recommended. For example, the content to be recommended to a user may be a product of an online store or an electronic commerce (EC) site.

The recommendation system 10 provides a recommendation, for example, by transmitting information related to the recommendation to a terminal 20 which is used by a user. The terminal 20 is a device that can transmit and receive information to and from the recommendation system 10 via a network such as a mobile communication network and process information related to a recommendation. The terminal 20 is a device such as a mobile phone, a smartphone, or a personal computer (PC). Transmission and reception of information related to a recommendation in the terminal 20 with respect to the recommendation system 10 and inputting and outputting of the information may be performed by a dedicated application installed in the terminal 20. A part of information used in the recommendation system 10 may be acquired by the terminal 20 and transmitted to the recommendation system 10.

The recommendation system 10 is constituted by a computer such as a personal computer (PC) or a server device having a communication function. The recommendation system 10 may be constituted by a plurality of computers. The recommendation system 10 can transmit and receive information to and from the terminal 20 via a network such as a mobile communication network.

The recommendation system 10 determines content (a restaurant) to be recommended for each user. The recommendation system 10 determines a recommendation expression for each recommendation and provides a recommendation in the determined expression. The recommendation expression is, for example, nudge wordings which are wordings used to recommend content. The recommendation expression is based on a user's psychological bias (hereinafter, referred to as a psychology bias) (a cognitive bias). The psychological bias is a psychological tendency when a user determines a behavior in response to a recommendation. Examples of such a psychological bias include “loss aversion” of disliking a loss and “conformity” of conforming to others.

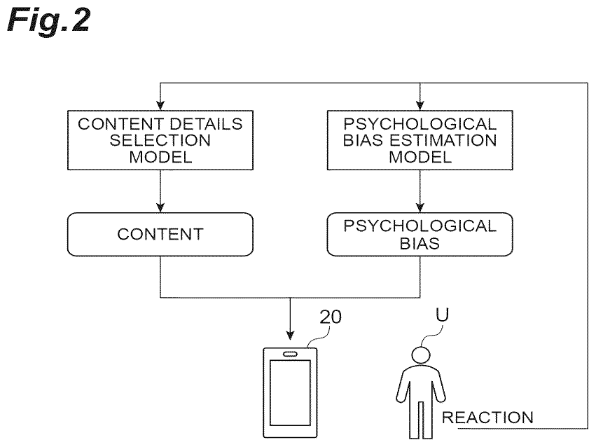

As illustrated in FIG. 2, for example, the recommendation system 10 stores a content details selection model in advance and determines content to be recommended on the basis of the content details selection model. The recommendation system 10 stores a psychological bias estimation model in advance, estimates a psychological bias on the basis of the psychological bias estimation model, and determines an expression based on the estimated psychological bias. The recommendation system 10 recommends the determined content to a user U in the determined expression. Accordingly, it is possible to enhance a recommendation effect for individual users. For example, content tailored to a user's interest or taste can be recommended in an expression in which the user is considered to want to use the content (for example, the user wants to visit a restaurant).

The recommendation expression does not have to be based on a psychological bias as long as it can affect a recommendation. The recommendation expression may be other than wordings at the time of recommendation.

In this embodiment, the recommendation system 10 performs learning of the psychological bias estimation model on the basis of a reaction of a user U which is a behavior of the user U in response to a recommendation. That is, the recommendation system 10 performs reinforcement learning for a recommendation determining method. The recommendation system 10 may also perform learning of the content details selection model on the basis of a reaction of a user U in response to a recommendation. It is possible to enhance the accuracy of recommendations through these learning processes.

Functions of the recommendation system 10 according to this embodiment will be described below. As illustrated in FIG. 1, the recommendation system 10 includes a user information acquiring unit 11, a content determining unit 12, an expression determining unit 13, a difficulty information acquiring unit 14, a behavior information acquiring unit 15, and a learning unit 16.

The user information acquiring unit 11 is a functional unit configured to acquire user information related to a user to be provided with a recommendation. The user information acquired by the user information acquiring unit 11 is used for processes related to a recommendation which will be described later. What the user information is and how the user information is acquired and used will be The user information which will be described later is described later is only an example as long as it can be used for processes related to a recommendation.

Recommendation to a user by the recommendation system 10 may be performed in a push type. For example, the recommendation may be performed with a specific state of a user (a push trigger) as a trigger. For example, the recommendation may be performed when a position of a user enters a specific area in which the recommendation is performed. Alternatively, the recommendation may be performed when a user uses a specific transportation means (for example, a subway or a taxi). The user information acquiring unit 11 may acquire information for determination thereof from a terminal 20 carried by the user. For example, the user information acquiring unit 11 may acquire information indicating a position of the terminal 20 such as latitude and longitude and determine whether recommendation to the user is to be performed on the basis of the acquired information.

Recommendation to a user by the recommendation system 10 may be performed at other timings. For example, the recommendation may be performed at a preset timing or the recommendation may be performed with another trigger. Alternatively, the recommendation may be performed in response to a request from the terminal 20. The following functional units described below in association with recommendation to a user have only to operate at the timing at which the recommendation to a user is performed.

The content determining unit 12 is a functional unit configured to determine content to be recommended to a user on the basis of at least a part of the user information acquired by the user information acquiring unit 11. In this embodiment, the content determining unit 12 determines a restaurant as content to be recommended to a user. The content determining unit 12 determines recommendation details according to the content details selection model which will be described below.

As the user information used by the content determining unit 12, the user information acquiring unit 11 acquires information indicating a point of interest (POI) visit result of the user to be provided with a recommendation. A POI in this embodiment is a restaurant to be recommended. The POI visit result is the number of times the user visited each store (restaurant) in the past.

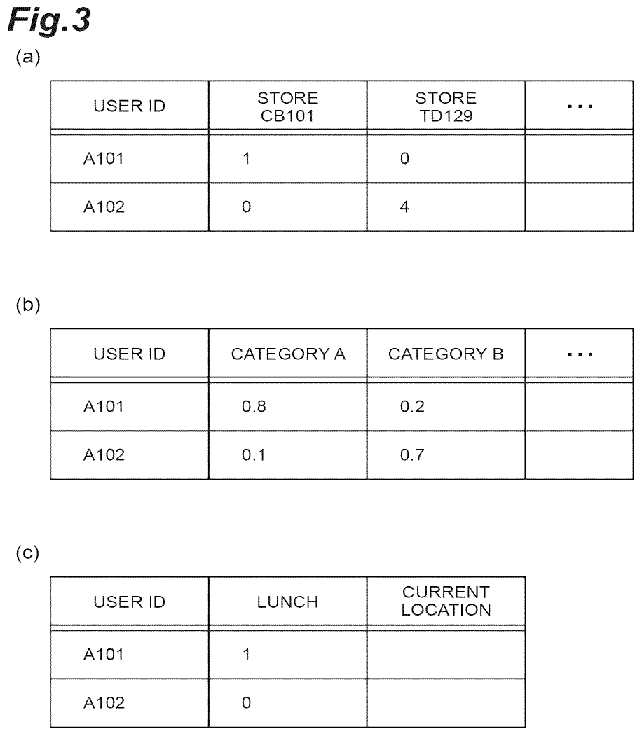

FIG. 3(a) illustrates a user-POI visit result database that stores information indicating POI visit results of a user and that is provided in the recommendation system 10. In the user-POI visit result database, a user ID and the number of past visits to each store by the user indicated by the user ID are correlated and stored in advance. The user ID is an identifier preset for the user to be provided with a recommendation. The information stored in the user-POI visit result database is generated using the related art or the like. For example, the information stored in the user-POI visit result database is generated on the basis of payment information of the user in a store or position information of the user. Generation of the information may be performed on the basis of a geofence. The user information acquiring unit 11 reads and acquires information of a user to be provided with a recommendation from the user-POI visit result database.

As the user information used by the content determining unit 12, the user information acquiring unit 11 acquires information indicating a degree of interest of a user to be provided with a recommendation in a category. The category is a category of a restaurant to be recommended. For example, the category includes “Yakiniku” and “Ramen.”

FIG. 3(b) illustrates a user-category interest information database that stores information indicating a degree of interest of a user in a category and that is provided in the recommendation system 10. In the user-category interest information database, a user ID and a numerical value indicating a degree of interest of a user indicated by the user ID in each category are correlated and stored in advance. The numerical value indicating a degree of interest represents that the user has a higher interest in the corresponding category as the value thereof becomes larger. The user-category interest information database is generated by the related art or the like. For example, the user-category interest information database is generated on the basis of the number of times a user visited stores in each category in the past, questionnaires of the user and the like. The user information acquiring unit 11 reads and acquires information of a user to be provided with a recommendation from the user-category interest information database.

As the user information used by the content determining unit 12, the user information acquiring unit 11 acquires information indicating a situation of a user to be provided with a recommendation at the time of recommendation, that is, information indicating a current situation of the user. For example, the information indicating a current situation of a user is information indicating whether the user had a lunch on that day and position information of the user.

FIG. 3(c) illustrates a user current situation database that stores information indicating a current situation of a user, that is used by the content determining unit 12, and that is provided in the recommendation system 10. In the user current situation database, a user ID and information indicating a current situation of a user indicated by the user ID are correlated and stored. Information of lunch in the information indicating the current situation represents that the user had a lunch on that day when the numerical value is 1 and represents that the user has not have a lunch on that day when the numerical value is 0. This information is generated in real time by the related art or the like.

Information of a current location in the information indicating the current situation is information indicating a current location of the user. For example, the information of the current location is information of latitude and longitude. For example, this information is generated (acquired) in real time by acquiring information indicating a current location of a terminal 20 from the terminal 20 carried by the user. The user information acquiring unit 11 reads and acquires information of a user to be provided with a recommendation from the user current situation database.

The user information acquiring unit 11 outputs the acquired information to the content determining unit 12. The user information acquiring unit 11 may acquire user information other than described above as the user information used by the content determining unit 12. The user information acquiring unit 11 may acquire user information using a method other than described above. For example, the user information acquiring unit 11 may acquire the user information by receiving the user information from the terminal 20.

The content determining unit 12 receives user information from the user information acquiring unit 11. The content determining unit 12 acquires information related to stores serving as candidates to be recommended to a user.

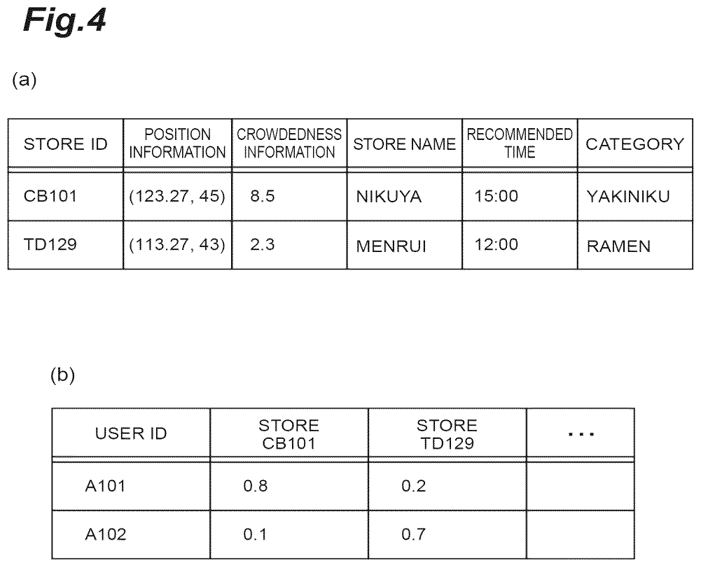

FIG. 4(a) illustrates a store database that stores information related to restaurants and that is provided in the recommendation system 10. In the store database, a store ID and information related to a store indicated by the store ID are correlated and stored. The stored ID is an identifier preset for a stored to be recommended to a user. As illustrated in FIG. 4(a), information related to a store includes information such as position information, crowdedness information, store name, recommended time, and category.

The position information is information indicating a position of a store. For example, the position information is information of latitude and longitude. The position information is stored in the store database in advance. The crowdedness information is information indicating crowdedness of a store. A numerical value of the crowdedness information represents that the store is more crowded as the value becomes larger. The crowdedness information is generated in real time by the related art or the like and is stored in the store database. The store name is a name of a store. The store name is stored in the store database in advance. The recommended time is a time of a day on which a visit to the store is recommended. The recommended time is stored in the store database in advance. The category is a category of the store. The category is one of the categories in the user-category interest information database illustrated in FIG. 3(b). The category is stored in the store database in advance.

The content determining unit 12 acquires information related to each restaurant from the store database. Stores serving as candidates to be recommended to a user may be some of the stores of which information is stored in the store database. For example, only stores based on a current location of a user may be set as candidates to be recommended to the user. Specifically, stores in a predetermined range from the current location of the user or stores in the same areas as the current location of the user (for example, stores in the same district or municipality) may be set as candidates to be recommended to the user. In this case, the content determining unit 12 may determine stores serving as candidates to be recommended to the user on the basis of the current location of the user indicated by the user information received from the user information acquiring unit 11 and positions of stores indicated by the acquired information related to restaurants.

The content determining unit 12 determines stores to be recommended to the user from the acquired information as will be described below. The content determining unit 12 first calculates a degree of behavior difficulty for each store of the candidates to be recommended. The degree of behavior difficulty is a degree of difficulty with which the user adopts a behavior with respect to a store. The behavior of the user with respect to the store is, for example, a behavior visiting the store, that is, a behavior of utilizing content. The behavior of the user with respect to the store is not limited thereto and may be any behavior with respect to the store such as unsealing and referring to information for recommending the store (that is, exhibiting an interest in the store (content), which will be described later in details).

An example of the calculated degree of behavior difficulty is illustrated in FIG. 4(b). The calculated degree of behavior difficulty is stored in a user-POI-behavior difficulty database provided in the recommendation system 10. A numerical value indicating a degree of behavior difficulty represents that the degree of difficulty is higher (that is, the user is less likely to adopt a behavior with respect to a corresponding store) as the value becomes smaller and the degree of difficulty is lower (that is, the user is more likely to adopt a behavior with respect to the corresponding store) as the value becomes larger.

For example, the content determining unit 12 calculates the degree of behavior difficulty for each store using the following expression.

Behavior difficulty=(f1 (number of visits)+degree of interest+f2 (distance from store))×s (whether user had meal)

In the expression, f1 (number of visits) is a function of which a function value is larger as the input the number of visits becomes larger. The number of visits is the number of past visits by a user to a store of which the degree of behavior difficulty is to be calculated. The degree of interest is a numerical value indicating an interest of the user in a category of the store of which the degree of behavior difficulty is to be calculated. f2 (distance from the store) is a function of which a function value is smaller as the input distance becomes larger. The distance from the store is a distance between the store of which the degree of behavior difficulty is to be calculated and the current location of the user. s (whether the user had a meal) is a value indicating whether the user had a meal. For example, when a recommendation in a time period of a lunch is provided, the value of s (whether the user had a meal) is 0 when the user had a lunch, and the value of s (whether the user had a meal) is 1 when the user has not have a lunch.

In the expression, the value of the degree of behavior difficulty with respect to a store becomes higher when the store is a store in which the number of visits by the user is large, a store of a category in which the user has a high interest, or a store which is close to the current location of the user. That is, such stores are stores with respect to a behavior the user is likely to adopt. When the user has not have a meal, the degree of behavior difficulty becomes higher and the user is more likely to adopt a behavior with respect to the store.

Calculation of the degree of behavior difficulty does not have to be performed using the aforementioned expression. All the aforementioned elements do not have to be used to calculate the degree of behavior difficulty, and only some thereof may be used to calculate the degree of behavior difficulty. An element other than described above may be used to calculate the degree of behavior difficulty. For example, crowdedness information and recommended time in the information related to the store are not used in the aforementioned expression, but such information may be used. For example, the value of the degree of behavior difficulty may become larger as the store is less crowded. Alternatively, the value of the degree of behavior difficulty may become larger as the recommended time becomes closer to the current time point.

The content determining unit 12 determines a store to be recommended to a user on the basis of the calculated degree of behavior difficulty. For example, the content determining unit 12 determines a store with the largest value of degree of behavior difficulty as the store to be recommended to a user. A store recommended already to the user to be provided with a recommendation in a predetermined period may be excluded from stores to be recommended. Here, the content determining unit 12 may determine a store to be recommended to a user on the basis of a determination criterion other than described above. When there is no store with a degree of behavior difficulty equal to or greater than a predetermined value, the content determining unit 12 may determine that no store is recommended to the user.

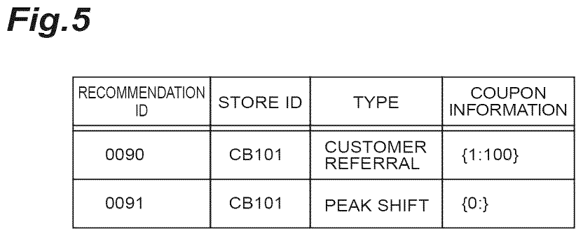

The content determining unit 12 may determine how a store is to be recommended, that is, a type of a recommendation. FIG. 5 illustrates a recommendation details database that stores details of recommendations and that is provided in the recommendation system 10. In the recommendation details database, a recommendation ID, a store ID, a type, and coupon information are correlated and stored in advance. The recommendation ID is an identifier preset for details of a recommendation. Details of a recommendation are identified by subsequent information. The store ID is a store ID of a store to be recommended.

The type is a recommendation type. Examples of the recommendation type include “customer referral” and “peak shift” illustrated in FIG. 5. Customer referral is to recommend a visit to a store to a user using coupons or other methods. Peak shift is to recommend a visit to a store to a user such that crowdedness is avoided when a facility (for example, a station) near the store is crowded.

Coupon information is information of a coupon that is presented to a user at the time of recommendation. The coupon information includes, for example, information indicating whether there is a coupon and information indicating details of the coupon. In the example illustrated in FIG. 5, the coupon information has a form of {A:B}. A is information indicating whether there is a coupon and indicates that there is a coupon when the numerical value thereof is 1 and there is no coupon when the numerical value thereof is 0. B indicates an amount of discount from a price as a coupon (for example, a coupon of 100 yen discount in data of the first row in FIG. 5). When the numerical value of A is 0, there is no information of B.

The content determining unit 12 determines details of a recommendation with reference to the recommendation details database after determining a store to be recommended. The content determining unit 12 stores a determination criterion for determining recommendation details in advance and determines details of a recommendation on the basis of the determination criterion. For example, the content determining unit 12 acquires information indicating a degree of crowdedness of a facility (for example, a station) near the store to be recommended to a user. This acquisition of information can be performed by the related art or the like. When the degree of crowdedness is equal to or greater than a preset threshold value, the content determining unit 12 determines that the type of peak shift is recommended. When the degree of crowdedness is less than the preset threshold value, the content determining unit 12 determines that the type of customer referral is recommended. The content determining unit 12 may determine details of a recommendation other than described above. A recommendation may be provided without using types such as customer referral and peak shift. The content details selection model defines processes for the content determining unit 12 to determine details of a recommendation.

The expression determining unit 13 is a functional unit configured to determine an expression when the content determined by the content determining unit 12 is recommended to a user on the basis of at least a part of the user information acquired by the user information acquiring unit 11. The expression determining unit 13 may determine an expression based on a psychological bias of a user to be provided with a recommendation as a recommendation expression. The expression determining unit 13 determines the recommendation expression according to the psychological bias estimation model which will be described below.

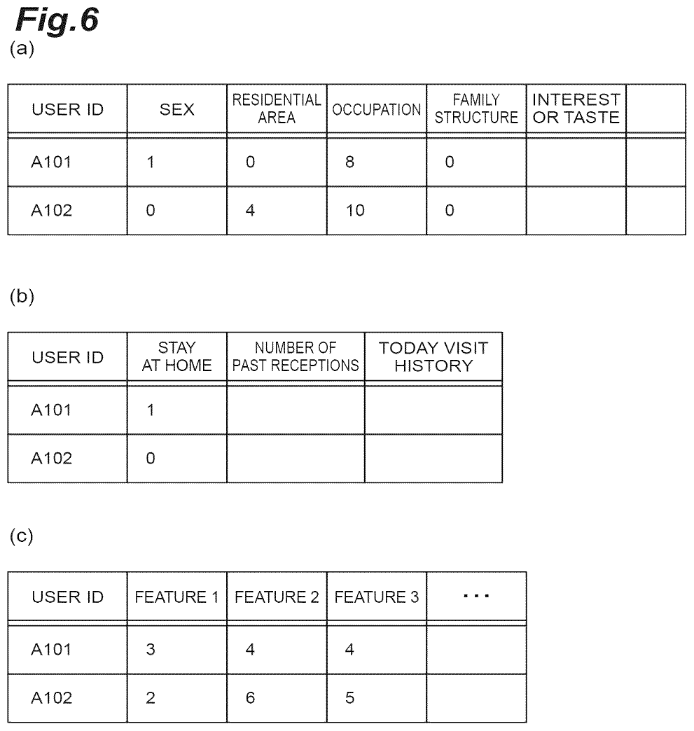

As the user information used by the expression determining unit 13, the user information acquiring unit 11 acquires information indicating attributes of a user to be provided with a recommendation. FIG. 6(a) illustrates a user attributes database that stores information indicating attributes of users and that is provided in the recommendation system 10. In the user attributes database, a user ID and information indicating attributes of the user indicated by the user ID are correlated and stored in advance. As illustrated in FIG. 6(a), attributes of a user include, for example, sex, residential area, occupation, family structure, and interest or taste. As illustrated in FIG. 6(a), information indicating attributes may be an ID indicating the attributes. The user information acquiring unit 11 reads and acquires information of a user to be provided with a recommendation from the user attributes database.

As the user information used by the expression determining unit 13, the user information acquiring unit 11 acquires information indicating a situation of a user to be provided with a recommendation at the time of recommendation, that is, information indicating a current situation of the user. For example, the information indicating a current situation of a user includes information indicating whether the user stays at home, the number of past receptions, and a today visit history. The number of past receptions is the number of times the user has received a recommendation in the past. The today visit history is information indicating whether the user has visited a store to be recommended to the user.

FIG. 6(b) illustrates a user current situation database that stores information indicating a current situation of a user and that is used by the expression determining unit 13 and that is provided in the recommendation system 10. In the user current situation database, a user ID and information indicating a current situation of the user indicated by the user ID are correlated and stored. Stay-at-home information in the information indicating a current situation represents that the user stays at home at that time when the numerical value thereof is 1 and the user does not stay at home at that time when the numerical value thereof is 0. This information is generated in real time by the related art or the like. The number of past receptions and the today visit history are appropriate information indicating that and is generated in real time by the related art or the like. The user information acquiring unit 11 reads and acquires information of a user to be provided with a recommendation from the user current situation database.

The user information acquiring unit 11 outputs the acquired information to the expression determining unit 13. The user information acquiring unit 11 may acquire user information other than described above as the user information used by the expression determining unit 13. The user information acquiring unit 11 may acquire the user information using a method other than described above. For example, the user information acquiring unit 11 may acquire the user information by receiving the user information from the terminal 20.

The expression determining unit 13 receives user information from the user information acquiring unit 11. The expression determining unit 13 determines a recommendation expression from the received information as will be described below. The expression determining unit 13 converts the received user information to a feature quantity. The feature quantity is a vector with a preset number of dimensions. Examples of the feature quantity which is a conversion result are illustrated in FIG. 6(c). Feature 1, feature 2, feature 3, . . . are elements of a feature quantity vector. Conversion from the user information to the feature quantity can be performed by the related art or the like.

The feature quantity may include information of external factors that can affect a recommendation other than the user information. For example, information indicating the weather and time at that time may be reflected in the feature quantity. Information related to the details of a recommendation determined by the content determining unit 12 may be reflected in the feature quantity. That is, the expression determining unit 13 may determine a recommendation expression additionally on the basis of the content determined by the content determining unit 12. For example, a category of a store (for example, a category “restaurant”) and a recommendation type (for example, a type “customer referral”) in the determined details of the recommendation may be included in the feature quantity. The information other than the user information can be converted to a feature quantity of a dimension different from that of the user information or a feature quantity combined with the user information.

The expression determining unit 13 estimates a psychological bias of a user on the basis of the acquired feature quantity and the psychological bias estimation model. Specifically, the expression determining unit 13 calculates an evaluation value for each (type of) psychological bias (for example, each of “loss aversion” and “conformity”). The psychological bias estimation model is used to calculate the evaluation value. The psychological bias estimation model includes a parameter for each psychological bias. The parameter is a vector with the same number of dimensions as that of the feature quantity. Elements of the parameter of the psychological bias estimation model correspond to elements of the feature quantity. The psychological bias estimation model is common among users. The psychological bias estimation model may be unique to each user or each type of users.

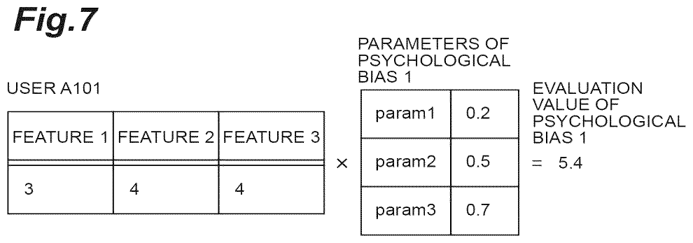

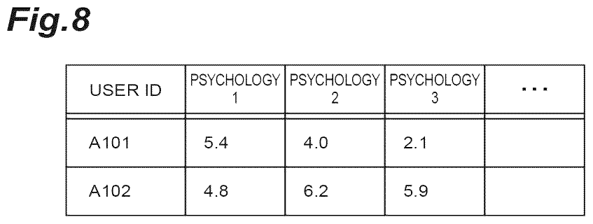

The expression determining unit 13 calculates an evaluation value by summing multiplied values of the elements of the feature quantity and the elements of the parameter of the psychological bias estimation model which correspond to each other. That is, the expression determining unit 13 calculates an inner product of a vector of the feature quantity and a vector of the parameter of the psychological bias estimation model as an evaluation value. The expression determining unit 13 calculates the evaluation value for each type of psychological bias using the parameter for each type of psychological bias. FIG. 7 illustrates an example of parameters of one psychological bias (psychological bias 1) and an example of calculation of an evaluation value. FIG. 8 illustrates evaluation values of psychological biases calculated for each user. The calculated evaluation value indicates that the user has the corresponding psychological bias more strongly as the value thereof becomes larger.

The parameters of the psychological bias estimation model are updated by learning in the learning unit 16 which will be described later. Learning in the learning unit 16 is performed on the basis of reactions of users to recommendations. Accordingly, determination of a psychological bias can be more appropriately performed whenever a recommendation is provided, and thus a recommendation can be more appropriately provided.

The expression determining unit 13 determines a nudge wording which is a recommendation expression on the basis of the estimated psychological bias. The expression determining unit 13 may refer to the information related to details of the recommendation determined by the content determining unit 12 and determine the recommendation expression on the basis of the information in addition to the estimated psychological bias.

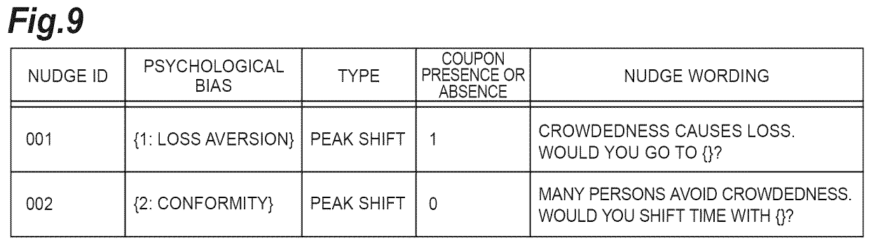

The recommendation expression is determined on the basis of a preset correlation between a psychological bias and a nudge wording. FIG. 9 illustrates a nudge wording database that stores information on the correlation and that is provided in the recommendation system 10. In the nudge wording database, a nudge ID, a psychological bias, a type, a coupon presence or absence, and a nudge wording are correlated and stored in advance. The nudge ID is an identifier preset for each nudge wording. The type is a recommendation type (such as “customer referral” and “peak shift” described above). The coupon presence or absence indicates whether or not there is a coupon presented to a user at the time of recommendation. The coupon presence or absence represents that there is a coupon when the numerical value thereof is 1 and there is no coupon when the numerical value is 0. The part of { } in each nudge wording is filled with information (for example, a store name) indicating a store to be recommended which is determined by the content determining unit 12.

The expression determining unit 13 stochastically determines (selects) a psychological bias which is used for a recommendation based on a ratio of the calculated evaluation values. By stochastically determining a psychological bias used for a recommendation in this way, it is possible to prevent the same nudge wording from being used always. Here, a psychological bias used for a recommendation may be determined using a method other than described above.

The expression determining unit 13 determines (selects) a nudge wording correlated with a combination of the determined psychological bias and the recommendation type and the coupon presence or absence determined by the content determining unit 12 in the nudge wording database as a recommendation expression for a user with reference to the nudge wording database illustrated in FIG. 9.

Although not included in the nudge wording database illustrated in FIG. 9, a wording based on whether or not there is a recommendation coupon may be included in the nudge wording. For example, when there is a recommendation coupon, a wording “there is a profitable coupon” may be included in addition to the nudge wordings illustrated in FIG. 9. When there is no recommendation coupon, a wording “recommend for you” may be included in addition to the nudge wordings illustrated in FIG. 9.

The expression determining unit 13 generates information to be recommended to a user using the recommendation details determined by the content determining unit 12 and the determined expression and transmits the generated to information the terminal 20. Recommendation itself such as transmission of the information to the terminal 20 based on the determination in the content determining unit 12 and the expression determining unit 13 does not have to be performed in the recommendation system 10, and may be performed by a system or a device other than the recommendation system 10.

The information to be recommended which has been transmitted to the terminal 20 is referred to by a user of the terminal 20. For example, when the information to be recommended is received by the terminal 20, the user is notified by a recommendation application. As the notification to the user, for example, information related to a recommendation is displayed on a screen of the terminal 20. This display for notification is performed such that details determined by the content determining unit 12 and the expression determining unit 13 can be recognized by the user. Specifically, the nudge wording, which includes information indicating a store to be recommended and determined by the content determining unit 12, determined by the expression determining unit 13 is displayed.

The user refers to details of the recommendation (for example, information of the store) by operating the application of the terminal 20. In this embodiment, this operation is referred to as unsealing. As described above, unsealing is also a behavior of the user with respect to the recommended store.

The difficulty information acquiring unit 14 is a functional unit configured to acquire difficulty information indicating a degree of difficulty with which the user adopts a behavior in response to the content determined by the content determining unit 12. The difficulty information acquiring unit 14 may acquire difficulty information indicating a degree of difficulty in which at least one of a past situation in which the user used the content, the user's interest, a user situation at the time of recommendation, and a content situation at the time of recommendation is reflected.

A reaction of the user to the recommendation is based on the recommended content (a restaurant in this embodiment) and a recommendation expression such as a nudge wording. Accordingly, when the user adopts a behavior such as unsealing the recommendation or visiting the recommended restaurant in response to the recommendation, it is conceivable that the nudge wording do not necessarily greatly affect the behavior but the recommended content itself greatly affect the behavior. For example, it is conceivable that the user adopts the behavior with respect to the recommended store because the user originally likes the recommended restaurant.

That is, the reaction of the user to the recommendation includes large noise in view of learning of the psychological bias estimation model. When learning is performed using data including noise, appropriate learning may not be performed, and learning of the psychological bias estimation model may not progress.

The degree of difficulty is for excluding an influence of the recommended content (a bias), that is, an influence of the user's interest or taste when learning of the psychological bias estimation model is performed on the basis of the reaction of the user to the recommendation. By performing the learning using the degree of difficulty, learning of the psychological bias estimation model can converge early.

The difficulty information acquiring unit 14 acquires information indicating the degree of behavior difficulty calculated by the content determining unit 12 as difficulty information for the recommended store. As described above, the degree of behavior difficulty calculated by the content determining unit 12 reflects at least one of the past situation in which the user used the content, the user's interest, the user situation at the time of recommendation, and the content situation at the time of recommendation. However, the difficulty information acquired by the difficulty information acquiring unit 14 does not have to be information indicating the degree of behavior difficulty calculated by the content determining unit 12, and the difficulty information acquiring unit 14 may acquire the difficulty information by calculating the degree of difficulty using a calculation method other than the calculation method performed by the content determining unit 12. The difficulty information acquiring unit 14 outputs the acquired difficulty information to the learning unit 16.

The behavior information acquiring unit 15 is a functional unit configured to acquire behavior information indicating the user's behavior in response to the recommendation to the user performed on the basis of the determinations in the content determining unit 12 and the expression determining unit 13. The user's behavior in response to the recommendation is, for example, unsealing and referring to the recommendation information, visiting the store and using a coupon included in the recommendation information in the store. The user's behavior in response to the recommendation can be any behavior adopted in response to the recommendation other than the aforementioned behaviors. Visiting the store and using the coupon may be regarded as the user's behavior in response to the recommendation only when the recommendation information is unsealed.

Specifically, the behavior information acquiring unit 15 acquires information indicating a time at which recommendation to the user has been performed, whether or not the recommendation information has been unsealed, unsealing time and whether or not the coupon has been used in the recommended store as the behavior information. The information indicating time at which recommendation to the user has been performed, whether or not the recommendation information has been unsealed, and the unsealing time can be acquired, for example, by the recommendation application in the terminal 20. The information indicating whether or not the coupon has been used can be acquired by acquiring information related to the user's payment in the recommended store. The behavior information acquiring unit 15 outputs the acquired behavior information to the learning unit 16.

The learning unit 16 is a functional unit configured to learn the determination method performed by the expression determining unit 13 in consideration of the degree of difficulty with which the user to be provided with a recommendation adopts a behavior on the basis of the difficulty information acquired by the difficulty information acquiring unit 14 and the behavior information acquired by the behavior information acquiring unit 15. The learning unit 16 may weight an evaluation value based on the behavior information using the difficult information and may learn the determination method performed by the expression determining unit 13 using the weighted evaluation value.

The learning unit 16 performs learning of the psychological bias estimation model on the basis of the difficulty information acquired by the difficulty information acquiring unit 14 and the behavior information acquired by the behavior information acquiring unit 15. Learning of the psychological bias estimation model is performed by the learning unit 16 such that the corresponding psychological bias is estimated to be strong when the user adopts a behavior in response to the recommendation. At that time, the learning is performed such that an influence of the recommended content is excluded on the basis of the difficulty information as described above. For example, the learning unit 16 performs learning of the psychological bias estimation model as will be described below.

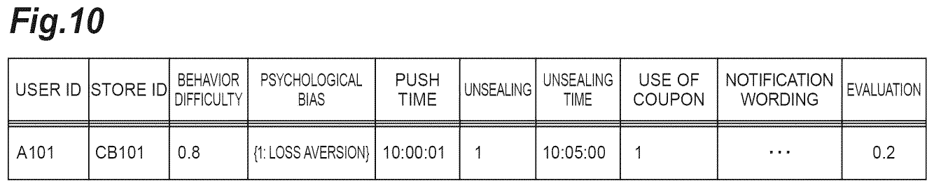

The learning unit 16 receives difficulty information from the difficulty information acquiring unit 14. The learning unit 16 receives behavior information from the behavior information acquiring unit 15. The learning unit 16 acquires information related to a recommendation corresponding to the difficulty information and the behavior information from the content determining unit 12 and the expression determining unit 13. The information acquired by the learning unit 16 is illustrated in FIG. 10. Information used for learning of the psychological bias estimation model out of the information illustrated in FIG. 10 includes information of behavior difficulty, psychological bias, push time, unsealing, unsealing time, and use of a coupon which are correlated with each other. Evaluation information illustrated in FIG. 10 will be described later.

The behavior difficulty is a degree of behavior difficulty with respect to a recommended store indicated by the difficulty information acquired by the difficulty information acquiring unit 14. The psychological bias is a psychology bias used for the recommendation determined by the expression determining unit 13. The learning unit 16 updates the parameters of the psychological bias estimation model for the psychological bias. The push time, the unsealing, the unsealing time, and the use of a coupon are behavior information acquired by the behavior information acquiring unit 15. The push time is a time at which recommendation to the user has been performed. The unsealing is information indicating whether or not the recommendation information has been unsealed by the user. The unsealing represents that unsealing of the recommendation information has been performed when the numerical value thereof is 1 and unsealing of the recommendation information has not been performed when the numerical value thereof is 0. The unsealing time is a time at which unsealing of the recommendation information has been performed by the user.

The use of a coupon is information indicating whether or not a coupon has been used by the user. The use of a coupon represents that a coupon has been used when the numerical value thereof is 1 and no coupon has been used when the numerical value thereof is 0. Information related to unsealing of the recommendation information and information related to the use of a coupon may be acquired in real time by the behavior information acquiring unit 15 or may be performed at a time point at which a preset time (for example, several minutes to several hours) has elapsed from the time at which recommendation to the user has been performed. When the information is acquired at the time point at which the preset time has elapsed, the information is information at that time point.

The learning unit 16 calculates a behavior modification evaluation value which is an evaluation value based on the behavior information from the behavior information. A behavior modification evaluation value when the corresponding behavior has been adopted is set for each behavior of the user in advance. For example, 0.2 is set for unsealing, and 0.8 is set for use of a coupon. The behavior modification evaluation value is an index value indicating how the user has adopted the behavior in response to the recommendation and represents that the user is more likely to adopt the behavior expected by a recommendation execution party as the value becomes larger. The learning unit 16 calculates the behavior modification evaluation value for the behavior adopted by the user with reference to the behavior information. When the user adopts a plurality of behaviors, a sum of values corresponding to the behaviors is calculated as the behavior modification evaluation value. In the example illustrated in FIG. 10, the user performs unsealing and use of a coupon, and thus the behavior modification evaluation value is 0.2 (unsealing)+0.8 (use of a coupon)=1.0.

The learning unit 16 weights the calculated behavior modification evaluation value on the basis of the difficulty information. For example, the learning unit 16 weights the behavior modification evaluation value with a value (1−behavior difficulty). In the example illustrated in FIG. 10, the weighted behavior modification evaluation value is (0.2 (unsealing)+0.8 (use of coupon))×(1−0.8 (behavior difficulty))=0.2. The evaluation illustrated in FIG. 10 is the weighted behavior modification evaluation value. Since the weight value based on the difficulty information employs a value obtained by subtracting the value of the degree of behavior difficulty therefrom, the weight value represents that the user is less likely to adopt a behavior as the value becomes larger.

Accordingly, the weighted behavior modification evaluation value is a value indicating the user's reaction to the recommendation from which an influence of the recommended content (a bias), that is, an influence of the user's interest or taste, has been excluded. When the difficulty information includes a situation of content (a store), an influence thereof is also excluded.

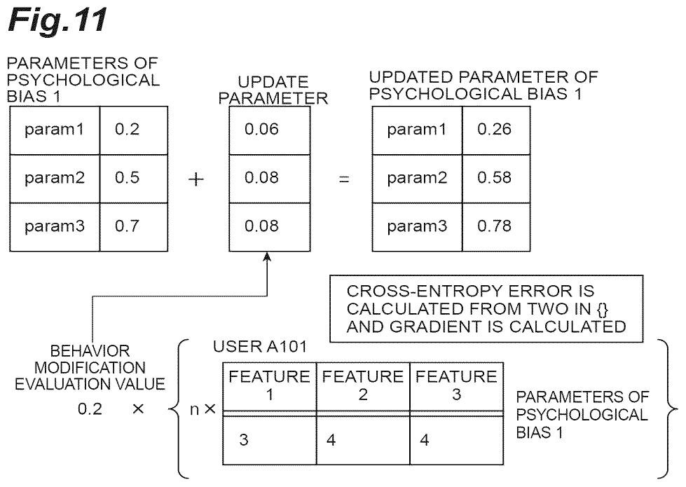

As illustrated in FIG. 11, the learning unit 16 subsequently calculates gradients of the feature quantity of the user used to calculate the evaluation value of the psychological bias and the parameter of the psychological bias estimation model to be updated. At the time of calculation of the gradients, the feature quantity of the user generally needs to be normalized such that the gradients can be appropriately calculated. In the normalization, for example, values of the elements of the feature quantity of the user may be multiplied by a preset value (n in FIG. 11). Other than the aforementioned method, the normalization may be performed using a preset function f with a feature quantity of a user as an input and with a normalized feature quantity as an output. The function f is for general normalization. The calculation of a gradient is performed by calculating a cross-entropy error from two vectors. Alternatively, the calculation of a gradient may be performed using a method other than the cross-entropy error. The calculated gradient is a vector with the same number of dimensions as that of the feature quantity and the parameter of the psychological bias estimation model.

The learning unit 16 calculates an update parameter by multiplying the elements of the gradient by the weighted behavior modification evaluation value. The learning unit 16 calculates an updated parameter (a trained parameter) by summing the parameter of the psychological bias estimation model to be updated and the update parameter for each element.

The psychological bias estimation model learned by the learning unit 16 is used for subsequent recommendation. Each time a recommendation is performed, learning of the learning unit 16 is repeated. By repeating the learning, it is possible to enhance the accuracy of the psychological bias estimation model and to determine a more appropriate recommendation expression.

The learning of the learning unit 16 does not need to be performed as described above as long as the learning is performed in consideration of a degree of difficulty with which a user to be provided with a recommendation adopts a behavior on the basis of the difficulty information and the behavior information.

The learning of the learning unit 16 may be performed at a timing at which a preset time has elapsed from a time at which a recommendation has been provided to a user or may be performed at a preset time (for example, a specific time on a day). Alternatively, the learning of the learning unit 16 may be performed at a timing at which the user has adopted a behavior in response to a recommendation within a limited time (for example, a preset time from the time at which the recommendation has been provided to the user). For example, behavior information acquiring unit 15 may acquire behavior information indicating that a user has adopted a behavior in response to a recommendation in real time and input the behavior information to the learning unit 16, and the learning unit 16 may perform learning when the behavior information is input from the behavior information acquiring unit 15. This is because the learning can be performed at the timing at which the behavior information indicating that a user has adopted a behavior in response to a recommendation is acquired. The learning unit 16 may train the content details selection model (a method of determining content to be recommended that is performed by the content determining unit 12) in addition to the psychological bias estimation model (the method of determining a recommendation expression that is performed by the expression determining unit 13). Training of the content details selection model can be performed by the related art or the like. The functions of the recommendation system 10 according to this embodiment have been described hitherto.

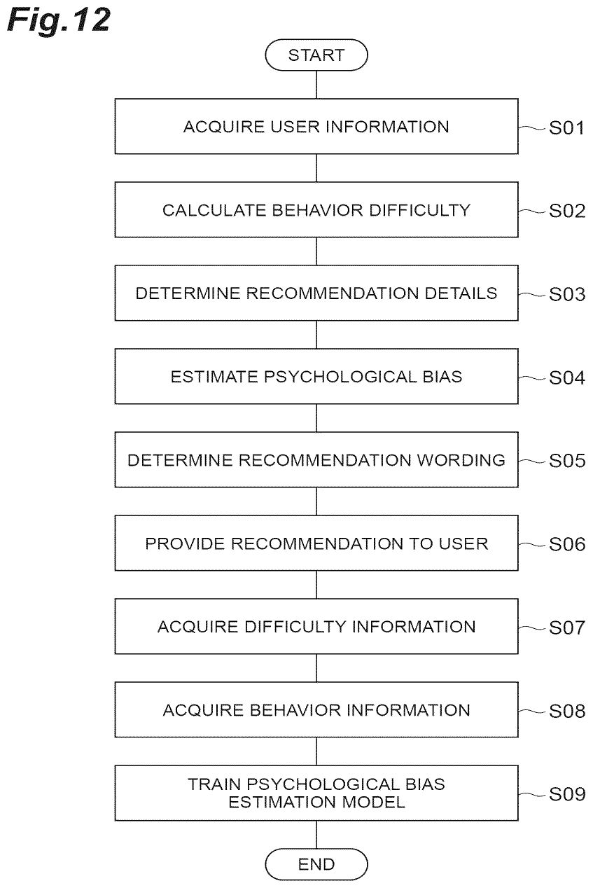

A process flow that is performed by the recommendation system 10 according to this embodiment (an operating method that is performed by the recommendation system 10) will be described below with reference to the flowchart illustrated in FIG. 12. This process flow is performed when a recommendation is provided to a user (for example, with the aforementioned push trigger as a trigger). First, the user information acquiring unit 11 acquires user information related to a user to be provided with a recommendation (S01). Subsequently, the content determining unit 12 calculates a degree of behavior difficulty for each store which is a candidate to be recommended (S02). This calculation is performed on the basis of the user information and information of stores. Subsequently, the content determining unit 12 determines a store to be recommended to the user, that is, recommendation details, on the basis of the degree of behavior difficulty (S03). At this time, a recommendation type such as “customer referral” or “peak shift” may be determined as described above.

Subsequently, the expression determining unit 13 estimates a psychological bias of the user using the psychological bias estimation model (S04). This estimation is performed on the basis of the user information. Subsequently, the expression determining unit 13 determines a nudge wording which is a recommendation expression on the basis of the estimated psychological bias (S05). The determining of a store to be recommended (S03) and the determining of a nudge wording (S05) may be performed in parallel. Subsequently, information of a recommendation is generated from the determined store and the determined nudge wording, and a recommendation is provided to the user (S06). The providing of a recommendation to the user is performed, for example, by transmitting the recommendation information to the terminal 20.

Subsequent processes are processes related to training of a psychological bias estimation model. These processes are based on the user's behavior in response to the recommendation and thus are normally performed in a predetermined time from the recommendation. In these processes, the difficulty information acquiring unit 14 acquires difficulty information indicating a degree of difficulty with which the user adopts a behavior with respect to content determined by the content determining unit 12 (S07). The behavior information acquiring unit 15 acquires behavior information indicating the user's behavior in response to the recommendation to the user (S08). Subsequently, the learning unit 16 trains the psychological bias estimation model in consideration of the degree of difficulty with which the user to be provided with a recommendation adopts a behavior on the basis of the difficulty information and the behavior information (S09). The trained psychological bias estimation model is used for subsequent recommendation to the user. The process flow that is performed by the recommendation system 1 according to this embodiment has been described hitherto.

In this embodiment, the degree of difficulty with which a user adopts a behavior with respect to content to be recommended is considered to train the psychological bias estimation model indicating the method of determining a recommendation expression. Accordingly, for example, it is possible to exclude an influence of a user's interest or taste from the user's behavior in response to a recommendation and to train the psychological bias estimation model. As a result, according to this embodiment, it is possible to more appropriately perform learning of the method of determining a recommendation expression.

As in this embodiment, training of the psychological bias estimation model may be performed using a weighted evaluation value acquired by weighting an evaluation value based on the behavior information (for example, the aforementioned behavior modification evaluation value) on the basis of the difficulty information. With this configuration, it is possible to more appropriately and reliably learn the method of determining a recommendation expression. For example, it is possible to reliably exclude an influence of a user's interest or taste from the user's behavior in response to a recommendation and to train the psychological bias estimation model. Training of the psychological bias estimation model does not have to be performed as described above as long as it can be performed in consideration of a degree of difficulty with which a user to be provided with a recommendation adopts a behavior on the basis of the difficulty information and the behavior information. Training of the psychological bias estimation model may be performed using the aforementioned bandit algorithm or may be performed another method.

In this embodiment, a recommendation expression may employ an expression based on a psychological bias of a user to be provided with a recommendation. With this configuration, it is possible to remind a user using an appropriate expression based on the user's psychological bias and to enhance a recommendation effect. Here, the recommendation expression does not have to be based on the psychological bias.

In this embodiment, the degree of difficulty indicated by the difficulty information may reflect at least one of a past situation in which the user used the content, the user's interest, a user situation at the time of recommendation, and a content situation at the time of recommendation. With this configuration, it is possible to make the difficulty information appropriate and reliable. As a result, it is possible to more appropriately and reliably learn the method of determining a recommendation expression. The degree of difficulty indicated by the difficulty information does not have to be the aforementioned ones as long as it is a degree of difficulty with which a user adopts a behavior with respect to content.

In this embodiment, the method of determining a recommendation expression is performed using a psychological bias estimation model, but the psychological bias estimation model does not have to be used. The method of determining a recommendation expression can employ an arbitrary one as long it can be trained in the aforementioned framework. Even when a psychological bias estimation model is used, the aforementioned psychological bias estimation model does not have to be used, and an arbitrary psychological bias estimation model can be used as long as it can be trained in the aforementioned framework.

The block diagrams used to describe the aforementioned embodiments show blocks of functional units. These functional blocks (constituent units) are realized by an arbitrary combination of at least one of hardware and software. The realization method of the functional blocks is not particularly limited. That is, each functional block may be realized by a single device which is physically or logically coupled, or may be realized by two or more devices which are physically or logically separated and which are directly or indirectly connected (for example, in a wired or wireless manner). Each functional block may be realized by combining software with the single device or the two or more devices.

The functions include determining, deciding, judging, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (a constituent unit) for transmitting is referred to as a transmitting unit or a transmitter. As described above, the realization method of each function is not particularly limited.

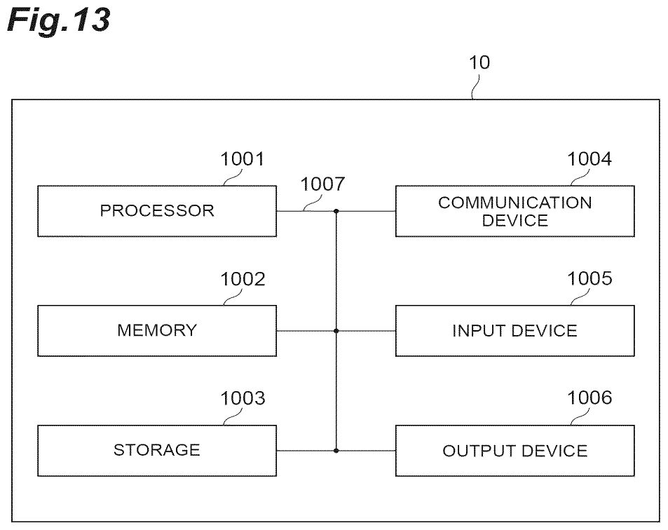

For example, the recommendation system 10 according to one embodiment of the present disclosure may serve as a computer that performs information processing according to the present disclosure. FIG. 13 is a diagram illustrating an example of a hardware configuration of the recommendation system 10 according to one embodiment of the present disclosure. The recommendation system 10 may be physically configured as a computer device including a processor 1001, a memory 1002, a storage 1003, a communication device 1004, an input device 1005, an output device 1006, and a bus 1007. The hardware configuration of the terminal 20 may be the same as described herein.

In the following description, the term “device” can be replaced with circuit, device, unit, or the like. The hardware configuration of the recommendation system 10 may be configured to include one or more devices illustrated in the drawing or may be configured to exclude some devices thereof.

The functions of the recommendation system 10 can be realized by reading predetermined software (programs) to hardware such as the processor 1001 and the memory 1002 and causing the processor 1001 to execute arithmetic operations and to control communication using the communication device 1004 or to control at least one of reading and writing of data with respect to the memory 1002 and the storage 1003.

The processor 1001 controls a computer as a whole, for example, by causing an operating system to operate. The processor 1001 may be configured as a central processing unit (CPU) including an interface with peripherals, a controller, an arithmetic operation unit, and a register. For example, the functions of the recommendation system 10 may be realized by the processor 1001.

The processor 1001 reads a program (program codes), a software module, data, or the like from at least one of the storage 1003 and the communication device 1004 to the memory 1002 and performs various processes in accordance therewith. As the program, a program that causes a computer to perform at least some of the operations described in the above-mentioned embodiment is used. For example, the functions of the recommendation system 10 may be realized by a control program which is stored in the memory 1002 and which operates in the processor 1001. The various processes described above are described as being performed by a single processor 1001, but they may be simultaneously or sequentially performed by two or more processors 1001. The processor 1001 may be mounted as one or more chips. The program may be transmitted from a network via an electrical telecommunication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store a program (program codes), a software module, and the like that can be executed to perform information processing according to one embodiment of the present disclosure.

The storage 1003 is a computer-readable recording medium and may be constituted by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage media of the recommendation system 10 may be, for example, a database, a server, or other appropriate media including at least one o the memory 1002 and the storage 1003.

The communication device 1004 is hardware (a transmitting and receiving device) that performs communication between computers via at least one of a wired network and a wireless network and is also referred to as, for example, a network device, a network controller, a network card, or a communication module.

The input device 1005 is an input device that receives an input from the outside (for example, a keyboard, a mouse, a microphone, a switch, a button, or a sensor). The output device 1006 is an output device that performs an output to the outside (for example, a display, a speaker, or an LED lamp). The input device 1005 and the output device 1006 may be configured as a unified body (for example, a touch panel).

The devices such as the processor 1001 and the memory 1002 are connected to each other via the bus 1007 for transmission of information. The bus 1007 may be constituted by a single bus or may be constituted by buses which are different depending on the devices.

The recommendation system 10 may be configured to include hardware such as a microprocessor, a digital signal processor (DSP), an application-specific integrated circuit (ASIC), a programmable logic device (PLD), or a field-programmable gate array (FPGA), and some or all of the functional blocks may be realized by the hardware. For example, the processor 1001 may be mounted using at least one piece of the hardware.

The order of processing steps, the sequences, the flowcharts, and the like of the aspects/embodiments described above in the present disclosure may be changed unless conflictions arise. For example, in the methods described in the present disclosure, various steps are described as elements in the exemplary order, and the methods are not limited to the described specific order.

Information or the like which is input or output may be stored in a specific place (for example, a memory) or may be managed using a management table. Information or the like which is input or output may be overwritten, updated, or added. Information or the like which is output may be deleted. Information or the like which is input may be transmitted to another device.

Determination may be performed using a value (0 or 1) which is expressed by one bit, may be performed using a Boolean value (true or false), or may be performed by comparison between numerical values (for example, comparison with a predetermined value).

The aspects/embodiments described in the present disclosure may be used alone, may be used in combination, or may be switched during implementation thereof. Notifying of predetermined information (for example, notifying that “it is X”) is not limited to explicit notification, and may be performed by implicit notification (for example, notifying of the predetermined information is not performed).

While the present disclosure has been described above in detail, it will be apparent that the present disclosure is not limited to the embodiments described in the present disclosure. The present disclosure can be altered or modified in various forms without departing from the gist and scope of the present disclosure defined by description in the appended claims. Accordingly, the description in the present disclosure is for exemplary explanation and does not have any restrictive meaning for the present disclosure.

Regardless of whether it is called software, firmware, middleware, microcode, hardware description language, or another name, software can be widely construed to refer to a command, a command set, a code, a code segment, a program code, a program, a sub program, a software module, an application, a software application, a software package, a routine, a sub routine, an object, an executable file, an execution thread, a sequence, a function, or the like.

Software, commands, information, and the like may be transmitted and received via a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), the at least one of wired technology and wireless technology is included in definition of the transmission medium.

Terms “system” and “network” used in the present disclosure are compatibly used.

Information, parameters, and the like described above in the present disclosure may be expressed using absolute values, may be expressed using values relative to predetermined values, or may be expressed using other corresponding information.

The term “determining” or “determination” used in the present disclosure may include various types of operations. For example, the term “determining” or “determination” may include cases in which judging, calculating, computing, processing, deriving, investigating, looking up, search, or inquiry (for example, looking up in a table, a database, or another data structure), and ascertaining are considered to be “determined.” The term “determining” or “determination” may include cases in which receiving (for example, receiving information), transmitting (for example, transmitting information), input, output, and accessing (for example, accessing data in a memory) are considered to be “determined.” The term “determining” or “determination” may include cases in which resolving, selecting, choosing, establishing, comparing, and the like are considered to be “determined.” That is, the term “determining” or “determination” can include cases in which a certain operation is considered to be “determined.” “Determining” may be replaced with “assuming,” “expecting,” “considering,” or the like.

The terms “connected” and “coupled” or all modifications thereof refer to all direct or indirect connecting or coupling between two or more elements, and can include a case in which one or more intermediate elements are present between the two elements “connected” or “coupled” to each other. Coupling or connecting between elements may be physical, logical, or a combination thereof. For example, “connecting” may be replaced with “accessing.” In the present disclosure, two elements can be considered to be “connected” or “coupled” to each other using at least one of one or more electrical wires, cables, and printed circuits and using electromagnetic energy or the like having wavelengths of a radio frequency area, a microwave area, and a light (both visible and invisible light) area in some non-limiting and non-inclusive examples.

The expression “based on ˜” used in the present disclosure does not mean “based on only ˜” unless otherwise described. In other words, the expression “based on ˜” means both “based on only ˜” and “based on at least ˜.”

No reference to elements named with “first,” “second,” or the like used in the present disclosure generally limit amounts or order of the elements. These naming can be used in the present disclosure as a convenient method for distinguishing two or more elements. Accordingly, reference to first and second elements does not mean that only two elements are employed or that a first element precedes a second element in any form.

When the terms “include” and “including” and modifications thereof are used in the present disclosure, the terms are intended to have a comprehensive meaning similarly to the term “comprising.” The term “or” used in the present disclosure is not intended to mean an exclusive logical sum.

In the present disclosure, for example, when an article such as “a,” “an,” or “the” in English is added in translation, the present disclosure may include a case in which a noun subsequent to the article is of a plural type.

In the present disclosure, the expression “A and B are different” may mean that “A and B are different from each other.” The expression may mean that “A and B are different from C.”

Expressions such as “separated” and “coupled” may be construed in the same way as “different.”

### REFERENCE SIGNS LIST

10 . . . Recommendation system, 11 . . . User information acquiring unit, 12 . . . Content determining unit, 13 . . . Expression determining unit, 14 . . . Difficulty information acquiring unit, 15 . . . Behavior information acquiring unit, 16 . . . Learning unit, 20 . . . Terminal, 1001 . . . Processor, 1002 . . . Memory, 1003 . . . Storage, 1004 . . . Communication device, 1005 . . . Input device, 1006 . . . Output device, 1007 . . . Bus

1. A recommendation system comprising circuitry configured to:
acquire user information related to a user to be provided with a recommendation;
determine content to be recommended to a user on the basis of at least a part of the acquired user information;
determine an expression when the determined content is recommended to the user on the basis of at least a part of the acquired user information;
acquire difficulty information indicating a degree of difficulty with which a user adopts a behavior with respect to the determined content;
acquire behavior information indicating a behavior of a user with respect to a recommendation provided to the user according to determination; and
learn a recommendation expression determination method in consideration of the degree of difficulty with which the user to be provided with a recommendation adopts a behavior on the basis of the acquired difficulty information and the acquired behavior information.

2. The recommendation system according to claim 1, wherein the circuitry weights an evaluation value based on the behavior information on the basis of the difficulty information and learns the recommendation expression determination method using the weighted evaluation value.

3. The recommendation system according to claim 1, wherein the circuitry determines an expression based on a psychological bias of a user to be provided with a recommendation as the expression at the time of recommendation.

4. The recommendation system according to claim 1, wherein the circuitry acquires difficulty information indicating the degree of difficulty in consideration of at least one of a past use situation of content of the user, the user's taste, a user situation at the time of recommendation, and a situation of content at the time of recommendation.

5. The recommendation system according to claim 2, wherein the circuitry determines an expression based on a psychological bias of a user to be provided with a recommendation as the expression at the time of recommendation.
